(19) United States
(12) Patent Application Publication
(10) Pub. No.: US 2019/0251973 A1
(43) Pub. Date: Aug. 15, 2019

(54) SPEECH PROVIDING METHOD, SPEECH PROVIDING SYSTEM AND SERVER

(71) Applicant: Toyota Jidosha Kabushiki Kaisha, Toyota-shi Aichi-ken (JP)

(72) Inventor: Satoshi Kume, Chofu-shi Tokyo (JP)

(73) Assignee: Toyota Jidosha Kabushiki Kaisha, Toyota-shi Aichi-ken (JP)

(21) Appl. No.: 16/273,342

(22) Filed: Feb. 12, 2019

(30) Foreign Application Priority Data
Feb. 13, 2018 (JP) 2018-023346

(51) Int. Cl. G10L 15/32; G06F 16/9032; G10L 15/20; H04R 3/12; H04R 5/04

(52) U.S. Cl. CPC G10L 15/32; G06F 16/90332; H04R 5/04; H04R 3/12; G10L 15/20

(57) ABSTRACT

A speech providing method includes causing a plurality of agents corresponding to a plurality of occupants to provide speech information to the corresponding occupants in a vehicle in which the plurality of occupants sits. The speech providing method includes: acquiring first speech information of a first agent which is provided to a first occupant; acquiring second speech information of a second agent which is provided to a second occupant; and controlling outputs of a plurality of speakers which is disposed at different positions in the vehicle such that a sound image of the first speech information and a sound image of the second speech information are localized at different positions.

### CROSS-REFERENCE TO RELATED APPLICATION

This application claims priority to Japanese Patent Application No. 2018-023346 filed on Feb. 13, 2018, incorporated herein by reference in its entirety.

### BACKGROUND

### 1. Technical Field

The disclosure relates to a speech providing method, a speech providing system and a server that provide speech information to a plurality of occupants aboard a vehicle.

### 2. Description of Related Art

Japanese Unexamined Patent Application Publication No. 2006-284454 (JP 2006-284454 A) discloses an onboard agent system in which a three-dimensional character image of an agent is disposed in a vehicle space to assist an occupant. The agent system includes a sound generating means for a character, and the sound generating means localizes a sound image at an appropriate position associated with assistance, for example, at a position at which an abnormality has occurred when an occupant is notified of an abnormality of a vehicle.

### SUMMARY

JP 2006-284454 A discloses that an agent outputs assistance information to a driver by speech, but does not disclose that a plurality of agents each outputs speech. When a plurality of agents outputs speech, it is preferable for it to be easy to ascertain to which occupant speech is output so that occupants can easily converse with the agents.

The disclosure provides a technique of allowing an occupant to distinguish speech for a plurality of agents when the plurality of agents outputs speech.

According to a first aspect of the disclosure, there is provided a speech providing method of causing a plurality of agents corresponding to a plurality of occupants to provide speech information to the corresponding occupants in a vehicle in which the plurality of occupants sits. The speech providing method includes: acquiring first speech information of a first agent which is provided to a first occupant; acquiring second speech information of a second agent which is provided to a second occupant; and controlling outputs of a plurality of speakers which is disposed at different positions in the vehicle such that a sound image of the first speech information and a sound image of the second speech information are localized at different positions.

According to this aspect, occupants can easily distinguish speech for a plurality of agents because the speech information of the plurality of agents is output with sound images localized at different positions.

Before controlling the outputs of the plurality of speakers, sitting positions of the first occupant and the second occupant in the vehicle may be identified. The sound images may be localized based on the sitting positions of the first occupant and the second occupant in the vehicle.

According to a second aspect of the disclosure, there is provided a speech providing system that causes a plurality of agents corresponding to a plurality of occupants to provide speech information to the corresponding occupants in a vehicle in which the plurality of occupants sits. The speech providing system includes: a plurality of speakers that is disposed at different positions in the vehicle; a first speech acquiring unit configured to acquire first speech information which a first agent provides to a first occupant; a second speech acquiring unit configured to acquire second speech information which a second agent provides to a second occupant; and a control unit configured to control outputs of the plurality of speakers such that a sound image of the first speech information and a sound image of the second speech information are localized at different positions.

According to this aspect, occupants can easily distinguish speech for a plurality of agents because the speech information of the plurality of agents is output with sound images localized at different positions.

According to a third aspect of the disclosure, there is provided a server configured to: receive first utterance information of a first occupant and second utterance information of a second occupant from a vehicle which includes a plurality of speakers and in which a plurality of occupants sits; determine, first speech information in response to the received first utterance information; determine second speech information in response to the received second utterance information; and transmit data for controlling outputs of the plurality of speakers to the vehicle such that a sound image of the first speech information and a sound image of the second speech information are localized at different positions.

According to the disclosure, it is possible to provide a technique of allowing an occupant to distinguish speech for a plurality of agents when the plurality of agents outputs speech.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a speech providing system according to an embodiment;

FIG. 2 is a diagram illustrating an agent displayed on a display; and

FIG. 3 is a diagram illustrating a functional configuration of the speech providing system.

### DETAILED DESCRIPTION

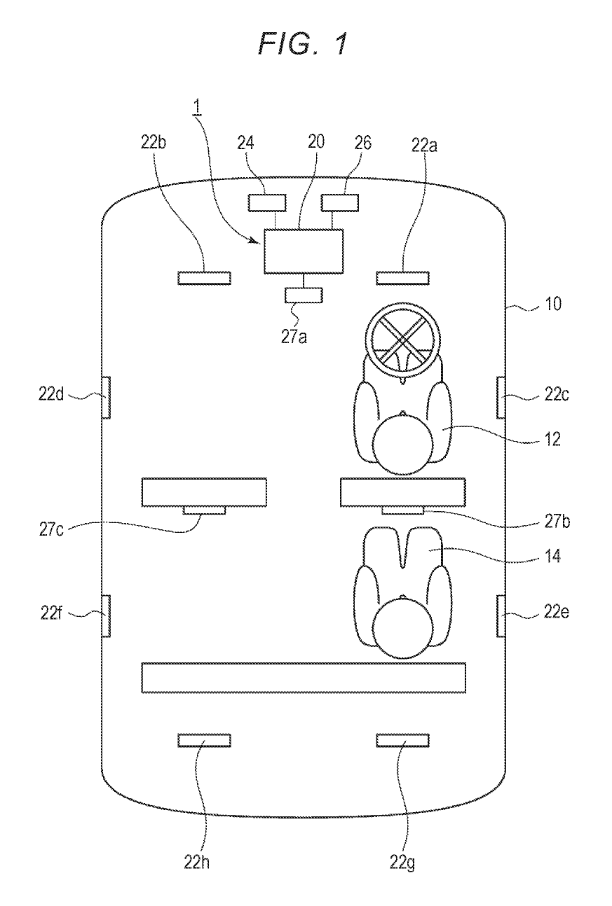

FIG. 1 is a diagram illustrating a speech providing system 1 according to an embodiment. In the speech providing system 1, a plurality of agents corresponding to a plurality of occupants provides speech to the corresponding occupants in a vehicle 10 in which the plurality of occupants sits. In FIG. 1, a first agent provides first speech information to a first occupant 12 who sits in the vehicle 10, a second agent provides second speech information to a second occupant 14 who sits in the vehicle 10, and the two agents have independent conversations.

An agent is displayed as an animation character on a display by executing an agent program and speech is output from speakers as if the character were talking. The first agent gives and receives information to and from a driver mainly by conversation, provides information by speech and/or an image, and provides information on traveling to support driving of the driver during traveling. A character of an agent may be displayed to be superimposed on an image representing a predetermined function and may be displayed, for example, at an end of a map which is displayed as a destination guidance function.

The speech providing system 1 includes a control unit 20, a first speaker 22a, a second speaker 22b, a third speaker 22c, a fourth speaker 22d, a fifth speaker 22e, a sixth speaker 22f, a seventh speaker 22g, and an eighth speaker 22h (which are simply referred to as “speakers 22” when the speakers are not distinguished), a microphone 24, a camera 26, and a first display 27a, a second display 27b, and a third display 27c (which are simply referred to as “displays 27” when the displays are not distinguished).

The microphone 24 is provided to detect sound in a vehicle compartment, converts sound including an utterance of an occupant into an electrical signal, and sends the signal to the control unit 20. The control unit 20 can acquire an utterance of an occupant from the sound information detected by the microphone 24.

The camera 26 captures an image of the interior of the vehicle and sends the captured image to the control unit 20. The control unit 20 can identify an occupant in the vehicle 10 by analyzing the captured image from the camera 26.

The plurality of speakers 22 is connected to the control unit 20 in a wired or wireless manner, are controlled by the control unit 20, and output speech information of the agents. The plurality of speakers 22 is disposed at different positions in the vehicle 10. The first speaker 22a and the second speaker 22b are disposed in front of a driver seat and a passenger seat, the third speaker 22c, the fourth speaker 22d, the fifth speaker 22e, and the sixth speaker 22f are disposed on both side walls of the vehicle, and the seventh speaker 22g and the eighth speaker 22h are disposed behind a rear seat.

The plurality of displays 27 is controlled by the control unit 20 and display an animation character as an agent. The first display 27a is disposed in an instrument panel or a center console located between the driver seat and the passenger seat and is located in the front of the driver seat and the passenger seat. The second display 27b is disposed on the back surface of the driver seat and the third display 27c is disposed on the back surface of the passenger seat.

The plurality of displays 27 may display different images. For example, the first display 27a may display the first agent corresponding to the first occupant 12 and the second display 27b may display the second agent corresponding to the second occupant 14. Accordingly, the first occupant 12 and the second occupant 14 can easily recognize the corresponding agents.

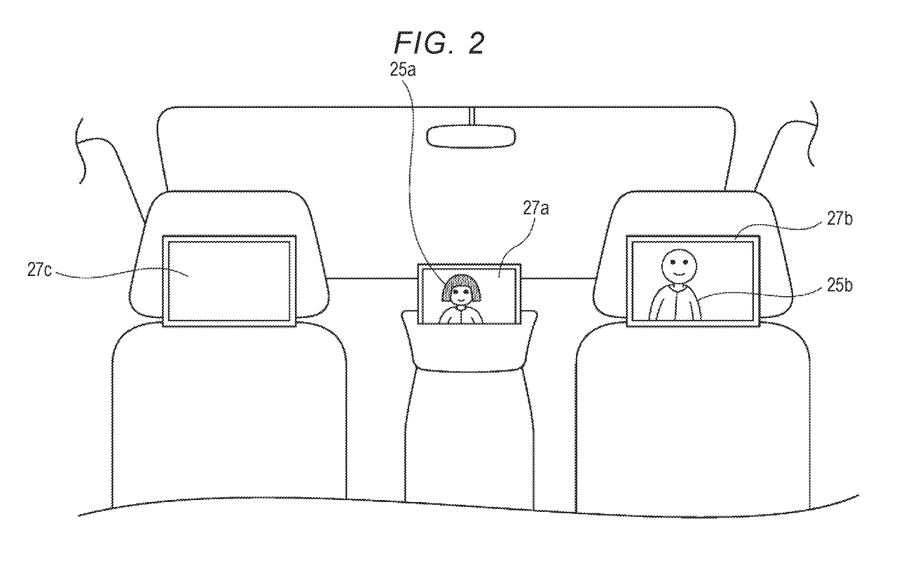

FIG. 2 is a diagram illustrating an agent displayed on the display 27. FIG. 2 illustrates an image of the vehicle interior when the front side is seen from the rear seat side in the vehicle 10 in which the first occupant 12 and the second occupant 14 sit as illustrated in FIG. 1.

The first agent 25a is displayed on the first display 27a and the second agent 25b is displayed on the second display 27b. The first agent 25a is controlled such that it converses with the first occupant 12 who sits in the driver seat, and the second agent 25b is controlled such that it converses with the second occupant 14 who sits in the right rear seat. The plurality of agents corresponding to the plurality of occupants provides speech to the corresponding occupants.

The plurality of speakers 22 is controlled such that a position of a sound image is localized at the position of the first display 27a when first speech information of the first agent 25a displayed on the first display 27a is output, and are controlled such that a position of a sound image is localized at the position of the second display 27b when second speech information of the second agent 25b displayed on the second display 27b is output. That is, the control unit 20 controls outputs of the plurality of speakers 22 such that the sound image of the first speech information and the sound image of the second speech information are localized at different positions. By localizing the first speech information for the first occupant 12 and the second speech information for the second occupant 14 at different positions, the occupants can easily recognize to what occupant speech information is provided.

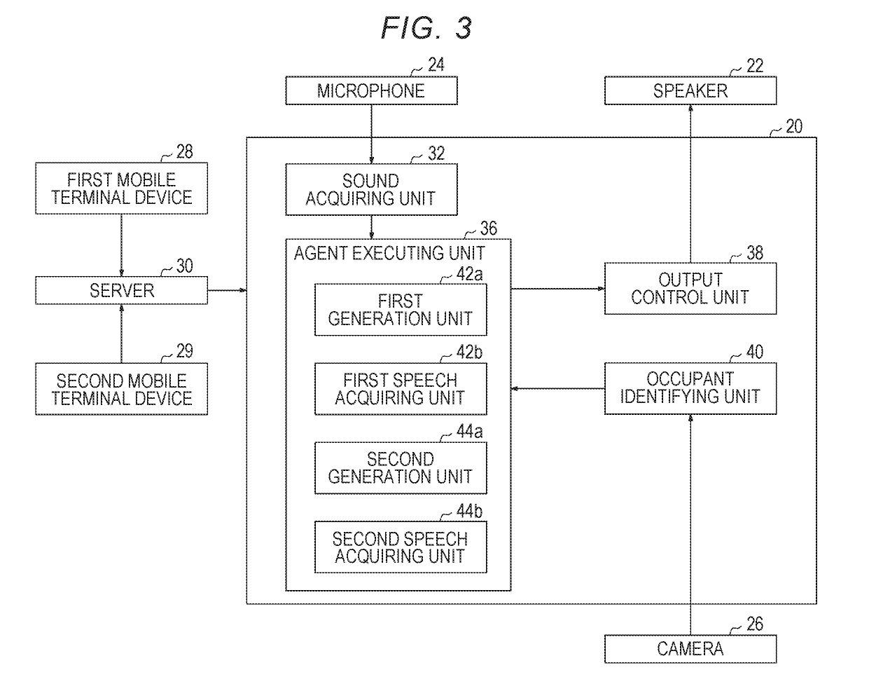

FIG. 3 is a diagram illustrating a functional configuration of the speech providing system 1. In FIG. 3, elements which are illustrated as functional blocks that perform various processes can be implemented by circuit blocks, a memory, and other LSIs in hardware and can be implemented by a program loaded into the memory or the like in software. Accordingly, it will be apparent to those skilled in the art that the functional blocks can be implemented in various forms by only hardware, by only software, or by a combination thereof, and the disclosure is not limited to one thereof.

The control unit 20 includes a sound acquiring unit 32, an agent executing unit 36, an output control unit 38, and an occupant identifying unit 40. The sound acquiring unit 32 acquires an utterance of an occupant from a signal detected by the microphone 24 and sends the acquired utterance of the occupant to the agent executing unit 36.

The occupant identifying, unit 40 receives a captured image from the camera 26, analyzes the captured image, and identifies an occupant who sits in the vehicle. The occupant identifying unit 40 stores information for identifying occupants, for example, attribute information such as face images, sexes, and ages of the occupants, in correlation with user IDs in advance and identifies an occupant based on the attribute information of the occupants. The attribute information of the occupants may be acquired from a first mobile terminal device 28 owned by the first occupant 12 or a second mobile terminal device 29 owned by the second occupant 14 via a server 30. When an onboard power supply is turned on or when a door of the vehicle is opened or closed, the occupant identifying unit 40 performs the process of identifying an occupant.

The occupant identifying unit 40 identifies an occupant included in the captured image in comparison with the attribute information and identifies a sitting position of the occupant. Position information of the occupant in the vehicle identified by the occupant identifying unit 40 and the user ID of the occupant are sent to the agent executing unit 36. The occupant identifying unit 40 may identify that an occupant has exited the vehicle.

The agent executing unit 36 executes an agent program and implements communication with the occupant by recognizing an utterance of the occupant and responding to the utterance. For example, in order to output the speech (sound image) “Where are you going?” from the speakers 22 to prompt the occupant to utter a destination, the agent executing unit 36 outputs a signal for the speech to the output control unit 38. When an utterance associated with a destination is acquired from a user via the sound acquiring unit 32, the agent executing unit 36 outputs tourism information and the like of the destination by speech from the speakers 22 and provides the speech to the occupant.

The agent executing unit 36 includes a first generation unit 42a, a first speech acquiring unit 42b, a second generation unit 44a, and a second speech acquiring unit 44b. The first generation unit 42a and the first speech acquiring unit 42b activate the first agent 25a conversing with the first occupant 12, and the second generation unit 44a and the second speech acquiring unit 44b activate the second agent 25b conversing with the second occupant 14.

The agent program which is executed by the agent executing unit 36 mounted in the vehicle is also executed in the first mobile terminal device 28 and the second mobile terminal device 29. The first mobile terminal device 28 is owned by the first occupant 12 and stores an agent program for activating the first agent 25a. The second mobile terminal device 29 is owned by the second occupant 14 and stores an agent program for activating the second agent 25b.

The first mobile terminal device 28 stores a user ID of the first occupant 12 and the second mobile terminal device 29 stores a user ID of the second occupant 14. The first mobile terminal device 28 sends the user ID of the first occupant 12 to the control unit 20 and thus the program for the first agent 25a which is being executed by the first mobile terminal device 28 is executed in the agent executing unit 36 mounted in the vehicle. The second mobile terminal device 29 sends the user ID of the second occupant 14 to the control unit 20 and thus the program for the second agent 25b which is being executed by the second mobile terminal device 29 is executed in the agent executing unit 36 mounted in the vehicle. The first mobile terminal device 28 and the second mobile terminal device 29 may send the user IDs as image information from the camera 26 or may send the user IDs directly to the control unit 20 using another communication means.

The first generation unit 42a and the first speech acquiring unit 42b start their execution upon receiving the user ID of the first occupant 12 from the first mobile terminal device 28 as a trigger, and the second generation unit 44a and the second speech acquiring unit 44b start their execution upon receiving the user ID of the second occupant 14 from the second mobile terminal device 29 as a trigger. The agent executing unit 36 may start its execution upon identifying a corresponding occupant by the occupant identifying unit 40 as a trigger.

The server 30 receives the user IDs and mobile terminal IDs from the first mobile terminal device 28 and the second mobile terminal device 29, receives a user ID and onboard device IDs front the control unit 20, and correlates the mobile terminal IDs and the onboard device IDs using the user IDs. Accordingly, the mobile terminal devices and the control unit 20 can transmit and receive information on the agents via the server 30.

When an occupant exits the vehicle 10, the occupant identifying unit 40 identifies that the occupant has exited and transmits the user ID of the occupant who has exited to the server 30. The server 30 notifies the mobile terminal device of the occupant that the occupant has exited based on the mobile terminal ID correlated with the user ID of the occupant who has exited. The mobile terminal device having been notified executes the agent program to display an agent. In this way, the agent is controlled to move by the mobile terminal device and the onboard control unit 20.

The first generation unit 42a generates first speech information which is provided to the first occupant 12. The first speech information is generated as a combination of a plurality of types of speech which is stored in advance in the control unit 20. The first generation unit 42a determines a display 27 on which a first agent character is to be displayed based on the position information of the occupants and determines the position of a sound image of the first speech information. The first speech acquiring unit 42b acquires the first speech if generated by the first generation unit 42a, the information on the display 27 on which the first agent character is to be displayed, and the position of the sound image of the first speech information and sends the acquired information on the agent to the output control unit 38.

The second generation unit 44a generates second speech information which, is provided to the second occupant 14. The second speech information is generated as a combination of a plurality of types of speech which is stored in advance in the control unit 20. The second generation unit 44a determines a display 27 on which a second agent character is to be displayed based on the position information of the occupants and determines the position of a sound image of the second speech information. The second speech acquiring unit 44b acquires the second speech information generated by the second generation unit 44a, the information on the display 27 on which the second agent character is to be displayed, and the position of the sound image of the second speech information and sends the acquired information on the agent to the output control unit 38.

The output control unit 38 controls the outputs of the plurality of speakers 22 such that the sound image of the first speech information and the sound image of the second speech information are localized at different positions. Since the occupant recognizes a position of a sound image based on a difference in an arrival time or a sound volume of sound reaching his or her right and left ears, the output control unit 38 sets sound volumes and phases of the plurality of speakers 22 and localizes the sound images at the positions determined by the agent executing unit 36. The output control unit 38 may store a control table with positions of sound images and may set sound volumes and phases of the plurality of speakers 22 with reference to the control table.

When the first speech acquiring unit 42b displays the first agent character on the first display 27a and acquires first speech information provided to the first occupant 12, the output control unit 38 controls the output of the speakers 22 such that the sound image is localized at the position or the first display 27a. When the second speech acquiring unit 44b displays the second agent character on the second display 27b and acquires second speech information provided to the second occupant 14, the output control unit 38 controls the output of the speakers 22 such that the sound image is localized at the position of the second display 27b. That is, the sound images of the speech information are localized at the positions of the displays on which the agent characters are displayed. In this way, the output control unit 38 changes the sound volumes and the phases of the plurality of speakers 22 depending on the positions of the occupants corresponding to the agents and localizes the positions of the sound images at different positions. Accordingly, each occupant can easily recognize to what occupant speech information has been provided.

When speech information is provided to occupants who sit in the driver seat and the passenger seat, the output control unit 38 localizes sound images at positions in the front of the driver seat and the passenger seat. On the other hand, when speech information is provide to occupants who sit in the rear seats, the output control unit 38 localizes sound images at positions behind the driver seat and the passenger seat. Accordingly, the occupants can easily distinguish speech information by the agents.

The agent executing unit 36 determines that the agent characters are displayed on the displays 27 located at positions closest to the occupants corresponding to the agents or displays the agent characters on the displays 27 located at positions which can be seen best by the corresponding occupants and the sound images are localized on the displays 27. Accordingly, the occupants can easily converse with the corresponding agents.

In the embodiment, the agent executing unit 36 is provided in the control unit 20 mounted in the vehicle, but the disclosure is not limited to this aspect. The first generation unit 42a and the second generation unit 44a of the agent executing unit 36 may be provided in the server 30. The server 30 receives an utterance of an occupant from the sound acquiring unit 32, determines speech information which is returned, and sends the speech information which is provided to one occupant to the control unit 20. The first generation unit 42a and the second generation unit 44a which are provided in the server 30 may determine speech information which is provided to the occupants, may also determine images of the agents and the displays 27 on which the agents are displayed, and may send the speech information which is provided to the occupant to the control unit 20. The first speech acquiring unit 42b and the second speech acquiring unit 44b of the control unit 20 acquire the determined speech information from the server 30 and the output control unit 38 localizes sound images of the acquired speech information based on the positions of the corresponding occupants.

The occupant identifying unit 40 may be provided in the server 30. For example, the server 30 receives a captured image of the inside of the vehicle from the camera 26, identifies occupants included in the captured image, and derives position information of occupants. In this aspect, the server 30 may store attribute information which is used for the occupant identifying unit 40 to identify the occupants in advance or may receive the attribute information from the first mobile terminal device 28 and the second mobile terminal device 29. Accordingly, it is possible to reduce a processing load on the control unit 20 mounted in the vehicle.

The server 30 may determine positions at which sound images of speech information which is provided are localized and determine control parameters for determining the sound volumes and the phases of the speakers 22 such that the sound images are localized at the determined positions. In this way, by causing the server 30 to perform a process of calculating control parameters of the speakers 22, it is possible to reduce a processing load on the vehicle side.

The above-mentioned embodiment is merely an example and it will be understood by those skilled in the art that combinations of the elements can be modified in various forms and the modifications are also included in the scope of the disclosure.

In the above-mentioned embodiment, a plurality of displays 27 is provided, but the disclosure is not limited to this aspect. The number of displays 27 may be one, and the display 27 may be provided in an upper end part of an instrument panel or a center console. Even when the number of displays 27 is one, the output control unit 38 can localize sound images of speech information of agent characters corresponding to occupants at positions close to the corresponding occupants and thus the occupants can understand to what occupant speech information is provided.

What is claimed:

1. A speech providing method of causing a plurality of agents corresponding to a plurality of occupants to provide speech information to the corresponding occupants in a vehicle in which the plurality of occupants sits, the speech providing method comprising:
acquiring first speech information of a first agent which is provided to a first occupant;
acquiring second speech information of a second agent which is provided to a second occupant; and
controlling outputs of a plurality of speakers which is disposed at different positions of the vehicle such that a sound image of the first speech information and a sound image of the second speech information are localized at different positions.

2. The speech providing method according to claim 1, wherein sitting positions of the first occupant and the second occupant in the vehicle are identified before controlling the outputs of the plurality of speakers, and
wherein the sound images are localized based on the sit ng positions of the first occupant and the second occupant in the vehicle.

3. A speech providing system that causes a plurality of agents corresponding to a plurality of occupants to provide speech information to the corresponding occupants in a vehicle in which the plurality of occupants sits, the speech providing system comprising:
a plurality of speakers that is disposed at different positions in the vehicle;
a first speech acquiring unit configured to acquire first speech information which a first agent provides to a first occupant;
a second speech acquiring unit configured to acquire second speech information which a second agent provides to a second occupant; and
a control unit configured to control outputs of the plurality of speakers such that a sound image of the first speech information and a sound image of the second speech information are localized at different positions.

4. A server configured to:
receive first utterance information of a first occupant and second utterance information of a second occupant from a vehicle which includes a plurality of speakers and in which a plurality of occupants sits;
determine first speech information in response to the received first utterance information;
determine second speech information in response to the received second utterance information; and
transmit data for controlling outputs of the plurality of speakers to the vehicle such that a sound image of the first speech information and a sound image of the second speech information are localized at different positions.
